(19) United States
(12) Patent Application Publication
(10) Pub. No.: US 2024/0429003 A1
(43) Pub. Date: Dec. 26, 2024

(54) SWITCH FOR A POWER TOOL AND METHOD FOR SWITCHING ON A POWER TOOL

(71) Applicant: Hilti Aktiengesellschaft, Schaan (LI)

(72) Inventors: Thomas BLATZ, Landsberg am Lech (DE); Roland MEUER, Ettringen (DE)

(21) Appl. No.: 18/738,190

(22) Filed: Jun. 10, 2024

(30) Foreign Application Priority Data
Jun. 23, 2023 (EP) 23181108.4

(51) Int. Cl. H01H 13/08; H01H 13/02; H01H 13/06; H01H 13/18; H01H 13/704

(52) U.S. Cl. CPC H01H 13/08; H01H 13/023; H01H 13/06; H01H 13/186; H01H 13/704; H01H 2013/026; H01H 2223/003

(57) ABSTRACT

A switch for a power tool, the switch including a printed circuit board and a silicone layer. The printed circuit board has a first microswitch, while the silicone layer has a blocking switch, the silicone layer being present arranged on the printed circuit board such that an actuation of the blocking switch leads to an actuation of the first microswitch. Furthermore, the printed circuit board can have a second microswitch, and the silicone layer can have a membrane, an actuation of the membrane leading to an actuation of the second microswitch. A method for switching on a power tool, the power tool including a switch having a printed circuit board and a silicone layer. An ergonomically advantageous switch is also provided, which switch is furthermore well protected against dust, dirt and/or water and enables inadvertent switching on of the power tool to be effectively avoided.

This claims priority to European Patent Application EP 23181108.4, filed on Jun. 23, 2023 which is hereby incorporated by reference herein.

The present invention relates to a switch for a power tool, the switch comprising a printed circuit board and a silicone layer. In a second aspect, the invention relates to a method for switching on a power tool, the power tool comprising a switch having a printed circuit board and a silicone layer.

### BACKGROUND OF THE INVENTION

Mechanical switches for power tools which enable power tools to be switched on or off are known in the prior art. By way of example, WO 2022 117 409 A1 or WO 2022 117 311 A1 discloses such mechanical switches, with safety and unblocking mechanisms additionally being disclosed in order to prevent unwanted switching on of the power tool. The switching devices described in WO 2022 117 409 A1 or WO 2022 117 311 A1 have a switch-on lock and an actuation switch, the switch-on lock being configured to prevent contact between a spring element of the actuation switch and an electronic switching element in a blocking position of the switch-on lock and to permit same in an operating position of the switch-on lock. What is disadvantageous about such a solution, however, is that, after use of the power tool, the user of the power tool has to ensure that a component of the switching device is present in a blocking position in order that the power tool cannot inadvertently be switched on.

In order to overcome this disadvantage, the prior art has proposed providing an electronic switching solution in which the power tool is present unblocked only for a predefined time period, such that the power tool can be switched on. After the predefined time period has elapsed, the switching device returns to the blocking position and the power tool cannot inadvertently be switched on. Rather, the blocking position is associated with a safe locked state of the power tool which makes it possible to prevent the inadvertent switching on of the power tool as a result of a mechanical blockage.

By way of example, WO 2019 197 123 A1 discloses a purely electronic switching solution having a switch for activating the power tool. However, such a purely electronic solution is implementable only for certain power tools, such as, for example, grinders having a continuous running button, primarily for ergonomic reasons. For other types of equipment which run only when a switch is actuated continuously, the solution proposed in WO 2019 197 123 A1 may quickly lead to fatigue in the hand or individual parts of the hand of the user. Furthermore, effective protection of the switch and its components against dust, dirt and/or water is desirable for some power tools.

### SUMMARY OF THE INVENTION

It is an object of the present invention to overcome the above-described deficiencies and disadvantages of the prior art and to provide a switch for a power tool which allows the power tool to be effectively protected against inadvertent and unwanted switching on by the user and which has good ergonomics and also good protection against water, dirt and/or dust.

The invention provides a switch for a power tool, the switch comprising a printed circuit board and a silicone layer. The printed circuit board has a first microswitch, while the silicone layer has a blocking switch, the silicone layer being present arranged on the printed circuit board such that an actuation of the blocking switch leads to an actuation of the first microswitch.

Furthermore, the printed circuit board can have a second microswitch, and the silicone layer can have a membrane, an actuation of the membrane leading to an actuation of the second microswitch. In the context of the invention, it is preferred that the printed circuit board has at least one first and one second microswitch. By way of example, the printed circuit board can also have two, three or more microswitches of one type, all combinations of numbers of microswitches also being disclosed. By way of example, the printed circuit board can comprise one first microswitch and two second microswitches. This configuration of the printed circuit board is illustrated in FIG. 1, for example. The first microswitch can preferably be referred to as a blocking microswitch, while the second microswitch can be referred to as an on-off microswitch. The silicone layer comprises at least the aforementioned blocking switch, and optionally a membrane. The silicone layer can furthermore also comprise many other components and functionalities. The invention advantageously makes it possible to provide an electromechanical switch which combines the advantages of the known switches, without having the disadvantages thereof. In particular, the switch makes it possible to effectively prevent inadvertent or unwanted switching on of the power tool by the user. Furthermore, it has been found that the switch has good ergonomics and also good protection against water, dirt and/or dust.

In one particularly preferred configuration of the invention, the printed circuit board has a first microswitch and a second microswitch, and the silicone layer has a blocking switch and a membrane, the silicone layer being present arranged on the printed circuit board such that an actuation of the blocking switch leads to an actuation of the first microswitch, and an actuation of the membrane leading to an actuation of the second microswitch.

In an alternative configuration of the invention, the printed circuit board can have a substantially exposed second microswitch, the second microswitch being actuated by a switching section of a rotary lever of the switch. Preferably, the switching section is present arranged on a first side of the rotary lever of the switch, the rotary lever being able to rotate around a pivot point. In other words, the rotary lever is embodied so as to be rotatable about a pivot point, the pivot point separating the first side of the rotary lever from the second side of the rotary lever.

The functionality whereby an actuation of the blocking switch leads to an actuation of the blocking microswitch can be achieved for example by virtue of the printed circuit board and the silicone layer having approximately identical dimensions and footprints, the printed circuit board and the silicone layer being arranged one above the other such that the positions of the blocking switch and of the blocking microswitch correspond to one another. Furthermore, the positions of the membrane and of the on-off microswitch can also correspond to one another. Preferably, the positions of the blocking switch and of the blocking microswitch or the positions of the membrane and of the on-off microswitch can be present arranged directly one above the other or one below the other, for example, such that when the switch is assembled, the blocking switch and the membrane become located directly on the blocking microswitch and the on-off microswitch. In other words, the positions of the blocking switch and of the first microswitch can correspond to one another and the positions of the membrane and of the second microswitch can correspond to one another. This can preferably be achieved by virtue of the positions of the blocking switch and of the first microswitch or the positions of the membrane and of the second microswitch being present arranged directly one above the other or one below the other, such that when the switch is assembled, the blocking switch and the membrane become located directly on the first and second microswitches.

In the context of the invention, it is preferred that the printed circuit board and the silicone layer form a switching unit within the switch, the switch preferably being present arranged in a handle of the power tool. The silicone covering mediated by the silicone layer of the switch can enable particularly good splash protection or particularly good protection of the switch and the component parts thereof against dirt, dust and/or water.

In the context of the invention, it is preferred that the printed circuit board also comprises a second microswitch besides the first microswitch. Moreover, the silicone layer can have a membrane, the silicone layer being present arranged on the printed circuit board such that an actuation of the membrane leads to an actuation of the second microswitch. This can be achieved for example by virtue of the silicone layer and the printed circuit board being arranged one above the other, such that the corresponding structural parts or components of the silicone layer and of the printed circuit board lie exactly or substantially one above the other or one on top of the other when the switch is assembled.

In the context of the invention, it is preferred that an actuation of the membrane and/or of the second microswitch is possible only if the blocking switch and/or the first microswitch have/has been actuated beforehand. An actuation of the membrane and/or of the second microswitch lying underneath advantageously leads to switching on of the power tool, such switching on of the power tool being possible only if the blocking switch and/or the first microswitch have/has been actuated beforehand. In order to switch on the power tool, firstly the blocking switch has to be actuated by a user of the power tool. For this purpose, the blocking switch can be pressed down, for example. An unblocked state of the power tool is activated by the actuation of the actuation switch, such that the power tool can be switched on after an actuation of the blocking switch by the user. By virtue of the user themself actuating the blocking switch, reference is made to a direct actuation of the blocking switch by the user in the context of the present invention.

The switching on is effected by the actuation of a membrane, this membrane being actuated only indirectly by the user themself. The power tool or the switch can comprise a rotary lever, the rotary lever having a switching section, which can actuate the membrane and thus the second microswitch. In other words, the switching section of the rotary lever can be configured to actuate the membrane and/or the on-off microswitch when the rotary lever is actuated by the user of the power tool. For the actuation, the rotary lever can have a gun handle section, which can be actuated, i.e. pulled in, by the user of the power tool in order to actuate the rotary lever preferably embodied so as to be rotatable. As a result of the rotation of the rotary lever, the switching section of the rotary lever can be pressed onto the membrane, such that the second microswitch is actuated or pressed, such that the power tool is switched on.

In the context of the invention, it is preferred that an actuation of the membrane and/or of the second microswitch lying underneath is effected by an actuation of a gun handle section, the gun handle section being present arranged on a second side of a rotary lever of the switch. The provision of a gun handle section can enable particularly good ergonomics of the switch. Preferably, the rotary lever is embodied so as to be rotatable about a pivot point, the pivot point subdividing the rotary lever into a first side and a second side, a switching section being present arranged on the first side of the pivot point, the switching section being configured to actuate the membrane and/or the on-off microswitch lying underneath. In the context of the invention, it is preferred that the first side of the rotary lever is present facing the switching unit of the switch. The second side of the rotary lever preferably comprises the gun handle section, at least one part of the gun handle section being able to be gripped or pulled in by the user of the power tool in order to start the power tool. In the context of the present invention, this starting of the power tool can be effected only if a blocking switch of the switch or of the switching unit has been actuated beforehand, such that a first microswitch and hence an unblocked state of the power tool is activated. In the context of the invention, it is preferred that the blocking switch and the blocking microswitch are activated directly by the user of the power tool, while the membrane and the on-off microswitch of the switch or of the switching unit are activated or actuated indirectly by means of a rotary lever.

In the context of the invention, it is preferred that the gun handle section of the rotary lever projects or is visible at least partly on an underside of a handle of the power tool, such that the gun handle section can be pressed by the user of the power tool in order—preferably indirectly—to switch on the power tool. By way of example, the gun handle section of the switch can be enclosed and then pressed by the fingers of a hand of the user when the power tool is in the unblocked state. In the context of the invention, it is preferred that the gun handle section of the switch is enclosed and subsequently pressed by at least one finger, but at most five fingers, of the user's hand. In order to activate the unblocked state on the power tool, the user—for example by way of a thumb—can actuate the blocking switch and thus the blocking microswitch, this actuation preferably being effected directly—by way of the user's thumb. This staggered switching-on process carried out using different regions of the human hand makes it possible, firstly, to provide a particularly safe power tool and, secondly, to enable ergonomically advantageous switching on of the power tool.

The unblocked state is preferably activated only for a short time period, which in the context of the invention is preferably referred to as “predefined time period”. The predefined time period can be for example in a range of 1 to 10 seconds, preferably 1 to 3 seconds. The time period can be for example 1 second or 2 or 3 seconds, where all intermediate values, such as 1.34 seconds, 2.5 seconds or 2.66 seconds, can also be preferred. It goes without saying that the time periods, for example in the range of 1 to 5 minutes (min), preferably 1 to 2 min, can also be preferred in the context of the present invention. The time period can for example also be in a range of between 10 and 60 seconds, by way of example 17 seconds, 20 seconds, 25 seconds, 33 seconds, 48.7 seconds or 50.06 seconds.

In the context of the invention, it is preferred that an actuation of the blocking switch and/or of the first microswitch leads to unblocking of the power tool, such that the power tool can be switched on. If the blocking switch and/or the blocking microswitch have/has been actuated, as a result the “unblocked state” can advantageously be activated, in which the power tool can be switched on. In the context of the invention, it is preferred that the power tool can be switched on only in this unblocked state. A particularly safe power tool which can be switched on only in very limited time periods can be provided as a result.

In the context of the invention, it is preferred that the unblocked state of the power tool is deactivated after a predefined time period has elapsed. The predefined time period can be for example in a range of 1 to 10 seconds, preferably 1 to 3 seconds.

In the context of the invention, it is preferred that the printed circuit board comprises light-emitting diodes, and the silicone layer has at least one see-through region embodied in a manner corresponding thereto, such that light emission by the light-emitting diodes can be recognized by a user of the power tool through the see-through region. In the context of the invention, for example, it can be preferred that the light-emitting diodes of the printed circuit board emit light when the unblocked state of the power tool is activated and the power tool is ready to be switched on. The user can recognize the unblocked state on the basis of the light emission by the light-emitting diodes of the proposed switch, and act accordingly. By way of example, the user can switch on the power tool if the light emission by the light-emitting diode on the switching unit enables the user to recognize that the power tool has been brought to the unblocked state by the actuation of the blocking switch or of the blocking microswitch. The user can also initiate measures to put the power tool into the blocked state again if the user does not actually want to work with the power tool. In the context of the invention, it is preferred that the power tool or the switch comprises means which enable the power tool to be brought from the unblocked state to the blocked state actively by the user. These means can be for example further actuation elements, such as switches or buttons, which can be actuated directly or indirectly by the user in order to end or deactivate the unblocked state, such that the power tool returns to the blocked state. In the context of the invention, it is preferred that the switch has means which enable an unblocked state of the power tool to be deactivated. In this case, the ending of the unblocked state and the return of the power tool to the blocked state can preferably be effected independently of the predefined time period, and instead by way of the user themself according to the manner in which they want to work with the power tool. The means which enable the power tool to be brought from the unblocked state to the blocked state actively by the user can also be referred to as a lock switch in the context of the invention. In the context of the invention, it is preferred that such a lock switch can assume two different states, between which the user can switch back and forth (“toggle switch”). In this case, in the context of the invention, it is preferred that a first state of the lock switch corresponds to the unblocked state of the power tool, while a second state of the lock switch corresponds to the blocked or locked state of the power tool.

In the context of the invention, it is preferred that the at least one see-through region is arranged on a top side of the blocking switch. As a result, the light emission by the light-emitting diode on the printed circuit board of the switch is particularly easily visible to the user, and the user can act according to the luminous signal. Preferably, the top side of the blocking switch is in a visual range or field of view of the user of the power tool, such that the user can quickly recognize when the light-emitting diode lights up or stops emitting light, i.e. a change in the luminous signal.

In the context of the invention, it is preferred that the switch has an unblocking device, the unblocking device having to be actuated in addition to the blocking switch and/or the first microswitch in order to activate an unblocked state of the power tool. The provision of the unblocking device makes it possible to provide an additional level of safety and to further increase safety when working with the power tool. In the context of the invention, it is preferred that the blocking switch and the unblocking device are actuated simultaneously or substantially simultaneously in order that the power tool undergoes transition to the unblocked state and can be switched on.

Alternatively, a preferred switching order can be manifested as follows:
1. unlocking of the power tool, for example by the blocking switch and/or the lock switch being actuated,
2. actuation of the unblocking device in order to mechanically release an on-off switch of the power tool, which switch can in particular be embodied as or comprise a gun handle section,
3. switching on of the power tool, for example by actuation of the on-off switch of the power tool.

Preferably, the actuation of the blocking switch and of the unblocking device is effected directly by the user, the user actuating the blocking switch and the unblocking device preferably in parallel or substantially in parallel. In the context of the invention, it is preferred that the unblocking device is present arranged on a top side of the switch, in which case the unblocking device can preferably be embodied as a pushbutton switch. In the context of the invention, it is very particularly preferred that the unblocking device is embodied as a mechanical detent pawl. The unblocking device or the mechanical detent pawl is preferably configured to mechanically release the on-off switch of the power tool, such that the power tool can be switched on. In other words, the power tool can be unlocked, i.e. be changed over from a blocked state to an unlocked state, by actuation of the unblocking device or the mechanical detent pawl. The on-off switch of the power tool can be embodied in particular as a so-called gun trigger. In the context of the invention, it is very particularly preferred that the on-off switch of the power tool is actuated by a ball of the thumb of a user of the power tool.

In the context of the invention, it is preferred that the unblocking device—if present—is actuated in addition to the blocking switch of the switching unit, i.e. are preferably pressed down in order to be able to switch on the power tool.

In the context of the invention, it is preferred that the switch has a spring fixing, the spring fixing preferably constituting a counterbearing and serving for supporting the second leg of the leg spring in the housing. In other words, the spring fixing is configured to support the leg spring or a part of the leg spring vis-à-vis the housing of the switch.

In the context of the invention, it is preferred that the printed circuit board has additional microcontrollers. The printed circuit board can then be used as a human-machine interface, for example. For this purpose, the printed circuit board can preferably also comprise further electronic components.

In a second aspect, the invention relates to a method for switching on a power tool, the power tool comprising a switch having a printed circuit board and a silicone layer. The terms, definitions and technical advantages introduced for the switch preferably apply analogously to the method for switching on the power tool. The method for switching on the power tool is characterized in that the printed circuit board has a first microswitch, and in that the silicone layer has a blocking switch, the silicone layer being present arranged on the printed circuit board such that an actuation of the blocking switch leads to an actuation of the first microswitch.

In the context of the invention, it is preferred that the power tool can be switched on only if the power tool is present in an unblocked state or if an unblocked state of the power tool is activated. This unblocked state can advantageously be produced by the blocking switch and/or the first microswitch being actuated—preferably directly—by a user of the power tool. The membrane or the on-off microswitch can then be actuated-preferably indirectly by means of a rotary lever—with the user pulling in or actuating a gun handle section of the rotary lever, whereby a switching section of the rotary lever preferably embodied so as to be rotatable makes contact with the membrane of the switching unit, such that the membrane is pressed down in one spatial direction and thus actuated. The “pressing down” of the membrane advantageously actuates the second microswitch, which causes the power tool to be switched on. As a result, the power tool is switched on when the unblocked state is activated on the power tool and the user pulls in the gun handle section of the rotary lever, such that the switching section of the rotary lever presses on the membrane and thus on the second microswitch. In the context of the invention, it is preferred that an actuation of the membrane and/or of the second microswitch lying underneath is possible only if the blocking switch and/or the first microswitch have/has been actuated beforehand. Preferably, an unblocked state of the power tool is activated by an actuation of the blocking switch and/or of the first microswitch.

In a very particularly preferred configuration of the invention, it is preferred that the printed circuit board also has a second microswitch besides the first microswitch, and the silicone layer also has a membrane besides the blocking switch, the silicone layer being present arranged on the printed circuit board such that an actuation of the membrane leads to an actuation of the second microswitch. In the context of the invention, it can also be preferred that the printed circuit board has a substantially exposed second microswitch, the second microswitch being actuated by a switching section of a rotary lever. In both cases, it can be preferred that an actuation of the membrane and/or of the second microswitch is possible only if the blocking switch and/or the first microswitch have/has been actuated beforehand.

The method for switching on the power tool can comprise the following steps, for example:
a) actuating the blocking switch of the silicone layer on the part of the user, whereby the first microswitch of the printed circuit board is actuated and the unblocked state of the power tool is activated,
b) actuating the gun handle section of the rotary lever on the part of the user, whereby the rotary lever is rotated and the switching section of the rotary lever is pressed on the membrane of the silicone layer, whereby the second microswitch of the printed circuit board is actuated and the power tool is switched on.

It should be noted here that the power tool can be switched on only if the blocking switch and/or the first microswitch of the switching unit have/has been actuated beforehand, such that the power tool is present in the unblocked state. If the blocking switch and/or the first microswitch of the switching unit have/has been actuated, the unblocked state is preferably activated for a predefined time period Δt. In other words, the power tool is present in the unblocked state during this predefined time period Δt and can be switched on. In the context of the invention, it is preferred that after the time period Δt has elapsed, the unblocked state ends of its own accord, i.e. preferably automatically, such that the unblocked state is deactivated. Consequently, after the time period Δt has elapsed, the power tool is preferably present in the blocked state, in which the power tool cannot be switched on, for safety reasons. As an alternative to the unblocked state being ended automatically, the power tool or the switch can comprise means which enable the unblocked state to be ended by the user of the power tool independently of the predefined time period Δt. These means for ending the unblocked state can be provided in the handle of the power tool, for example. Alternatively, the blocking switch can also be actuated again in order to end the unblocked state of the power tool, i.e. to change over the power tool from the unlocked state to the blocked state.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form sensible further combinations.

In the figures, identical components and components of identical type are designated by the same reference signs.

In the figures:

FIG. 1 shows a view of one preferred configuration of the switch, in particular of the switching unit

FIG. 2 shows a sectional illustration of one preferred configuration of the switch

FIG. 3 shows a sectional illustration of a further preferred configuration of the switch

FIG. 4 shows a view of one preferred configuration of the switch, in particular the partial integration thereof in the handle of a power tool

FIG. 5 shows a view of a further preferred configuration of the switch, in particular the partial integration thereof in the handle of a power tool.

### DETAILED DESCRIPTION

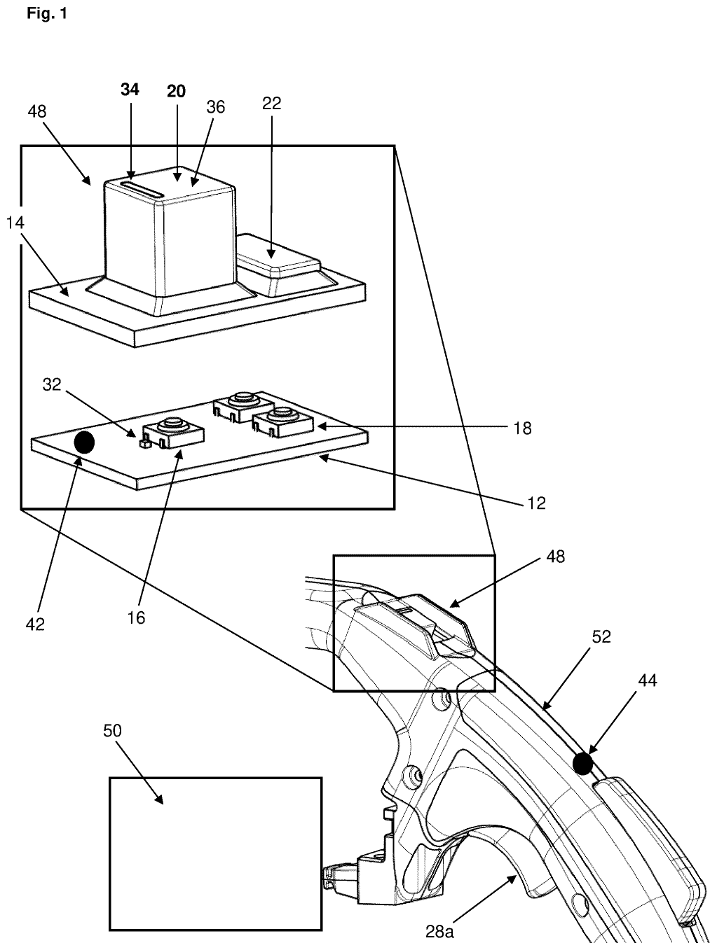

FIG. 1 shows one preferred configuration of a switching unit 48 of a proposed switch 10. A handle 52 of the power tool 50 (shown schematically) is illustrated in the bottom right region; the switching unit 48 of the proposed switch is depicted as a detail in the top left region. The switching unit 48 comprises a printed circuit board 12 and a silicone layer 14, the printed circuit board 12 comprising a first microswitch 16 and a second microswitch 18. The silicone layer 14 comprises a membrane 22 and a blocking switch 20. The first microswitch 16 of the printed circuit board 12 can preferably also be referred to as a “blocking microswitch”, while the second microswitch 18 of the printed circuit board 12 can preferably also be referred to as an “on-off microswitch”. The printed circuit board 12 and the silicone layer 14 preferably have substantially similar external dimensions and, in the exemplary embodiment of the invention illustrated in FIG. 1, are arranged one above the other such that the blocking switch 20 becomes located on the first microswitch 16 and the membrane 22 becomes located on the second microswitch 18. Consequently, the blocking switch 20 is present arranged on the first microswitch 60 and the membrane 22 is present arranged on the second microswitch 18 and an actuation of the blocking switch 20 leads to an actuation of the first microswitch 16, while an actuation of the membrane 22 leads to an actuation of the second microswitch 18. The power tool 50 (shown schematically in FIG. 1) can be changed over to an unblocked state by the actuation of the blocking switch 20 and/or of the first microswitch 16. That means that the unblocked state of the power tool 50 is activated by an actuation of the blocking switch 20 and/or of the first microswitch 16. The proposed switch 10 can be provided in a handle 52 of the power tool 50. The power tool 50 can be switched on only if the unblocked state of the power tool 50 is activated, i.e. if the power tool 50 is present in the unblocked state. In other words, the power tool 50 can be switched on only if the blocking switch 20 and/or the first microswitch 16 of the switch 10 have/has been actuated before the actual switching on, such that the power tool 50 is present in the unblocked state. The second microswitch 18 can also be present arranged substantially in an exposed fashion on the printed circuit board 12, such that the second microswitch 18 can be actuated directly or immediately by a switching section 26a of a rotary lever 24. In this configuration of the invention, it is preferred that the second microswitch 18 is not covered by a membrane 22.

Light-emitting diodes 32 can be arranged on the printed circuit board 12 of the switch 10, the light or light emission from which diodes is visible through see-through regions 34 of the silicone layer 14 or can be recognized by the user of the power tool 50. In the exemplary embodiment of the invention illustrated in FIG. 1, the position of the light emitting diode 32 corresponds to the position of the see-through region 34 on the top side 36 of the blocking switch 20, such that the light from the light-emitting diode 32 can be incident in the eye of the user of the power tool 50 through the see-through region 34—preferably embodied so as to be transparent—of the silicone layer 14. By way of example, light emission by the light-emitting diode 32 can symbolize that the power tool 50 is in the unblocked state and can be switched on. In this exemplary embodiment, the luminous signal of the light-emitting diode 32 can be understood as a warning signal. It is likewise conceivable for light emission by the light-emitting diode 32 to mean that the power tool 50 is present in the blocked state and cannot currently be switched on. In this exemplary embodiment, the luminous signal comprises, rather, an information signal. Besides the microswitches 16, 18 and the light-emitting diode 32, the printed circuit board 12 can comprise for example at least one microcontroller 42 or other electronic components, such as (micro) capacitors, for example. As a result, the printed circuit board 12 can be extended to form a human-machine interface.

FIG. 1 also illustrates means 44 enabling the unblocked state of the power tool 50 to be deactivated. These means 44 can be provided for example on or at the handle 52 of the power tool 50. Using the means 44, a user of the power tool 50 can end the unblocked state of the power tool 50. This can afford a possibility that there is no need to wait for the predefined time period to have elapsed in order to return to the blocked state of the power tool 50, rather the user can be enabled to change over the power tool 50 from the unblocked state to the blocked state actively and independently of the predefined time period.

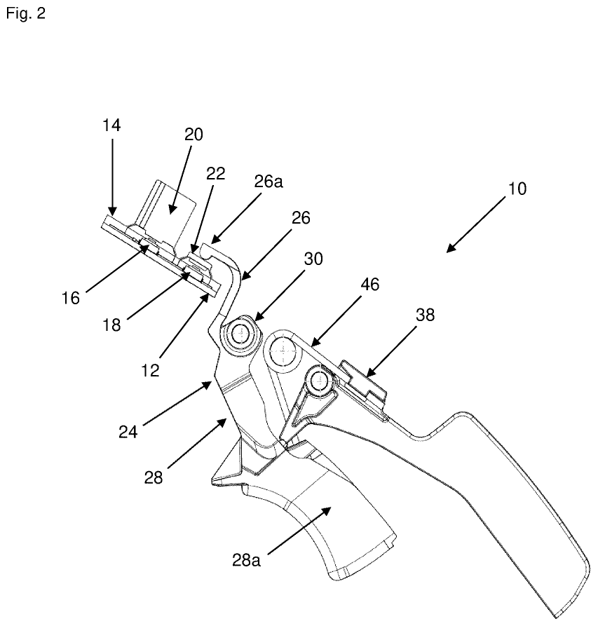

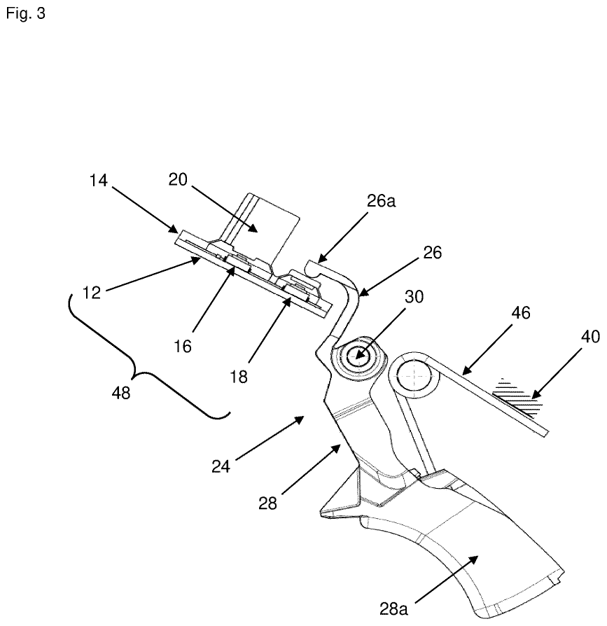

The actual switching on of the power tool 50 is preferably effected by way of an actuation of the membrane 22 and/or of the second microswitch 18. The actuation of the membrane 22 and/or of the second microswitch 18 is preferably effected indirectly by an actuation of a rotary lever 24, which is illustrated in FIGS. 2 and 3.

The rotary lever 24 is preferably arranged so as to be rotatable about a pivot point 30. The pivot point 30 divides the rotary lever 24 into two halves or two sides 26, 28. The first side 26 of the rotary lever 24 preferably faces the switching unit 48 of the switch 10 and can comprise a switching section 26a configured to make contact with the membrane 22 of the silicone layer 14 and to press down this membrane 22 and, as a result, to actuate the second microswitch 18 lying underneath. The rotation of the rotary lever 24 is preferably caused by the gun handle section 28a of the rotary lever 24 being pulled in by the user of the power tool 50. The gun handle section 28a is preferably part of the second side 28 of the rotary lever 24. Owing to the rotatability of the rotary lever 24, pulling in the gun handle section 28a leads to the switching section 26a of the rotary lever 24 being pressed down, i.e. the second side 28 of the rotary lever 24 is moved up by the gun handle section 28a being pulled in, whereby the first side 26 of the rotary lever 24 is pressed down and the power tool 50 is switched on by an actuation of the membrane 22 of the silicone layer 14 or the on-off microswitch 18 of the printed circuit board 12.

FIG. 2 shows one configuration of the switch 10 of an unblocking device 38, while FIG. 3 shows an alternative configuration of the switch 10 with a spring fixing 40.

The unblocking device 38 can constitute a further safety stage of the power tool 50, wherein the unblocking device 38 has to be actuated in addition to the blocking switch 20 in order that the unblocked state of the power tool 50 is activated. Preferably, the unblocking device 38 and the blocking switch 20 are pressed simultaneously or substantially simultaneously by the user of the power tool 50 in order to change over the power tool 50 to the unblocked state. Afterwards—as already described—the power tool 50 can be switched on by a direct actuation of the gun handle section 28a or an indirect actuation of the membrane 22 or of the second microswitch 18. In this case, the membrane 22 or the second microswitch 18 is actuated in particular by the switching section 26a of the rotary lever 24, which presses on the membrane 22 when the gun handle section 28a of the rotary lever 24 is pulled in by the user of the power tool 50.

FIG. 3 illustrates a configuration of the switch 10 with a spring fixing 40. The switch 10 can have a spring 46, wherein one leg of the spring 46 can be supported on the housing of the switch 10. The spring 46 can preferably be embodied as a leg spring comprising two spring legs.

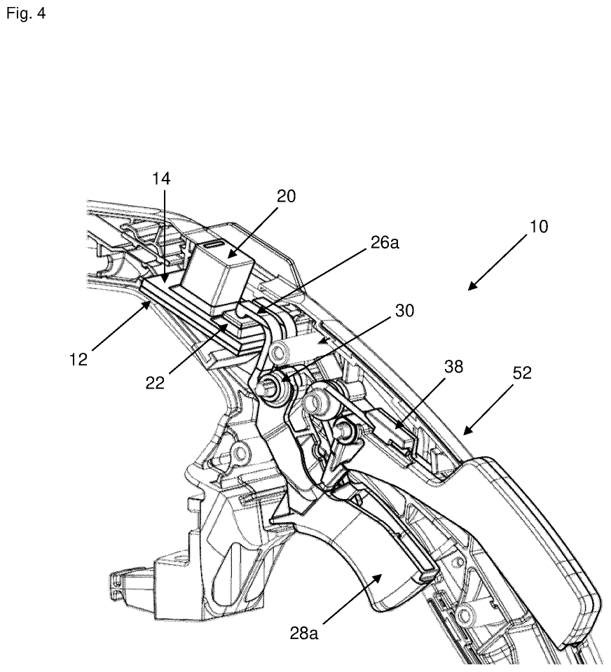

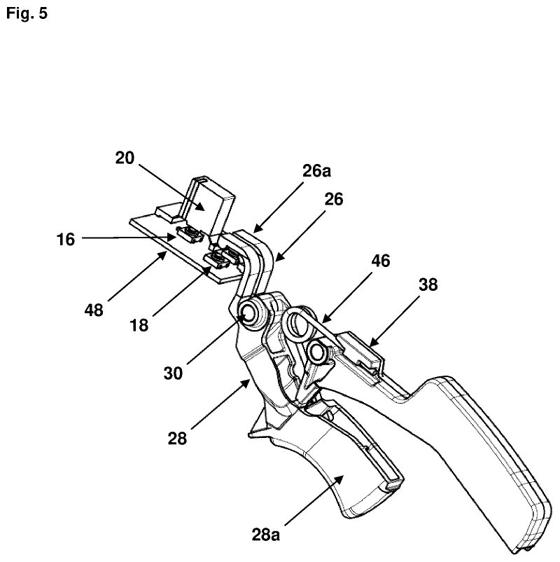

FIGS. 4 and 5 each show one preferred configuration of the proposed switch 10, in particular the partial integration thereof in the handle 52 of a power tool 50. By way of example, the switch 10 can be present arranged predominantly in the interior of two handle shells, the handle shells forming the handle 52 of the power tool 50. FIG. 4 shows a configuration of the switch 10 with an unblocking device 38, and FIG. 5 illustrates fewer component parts of the handle 52 of the power tool 50 in order to facilitate a clear view. What can be seen are the switching unit 48 with the printed circuit board 12 and the silicone layer 14 and also the components thereof, in particular the microswitches 16, 18 of the printed circuit board 12 and the membrane 22 and the blocking switch 20 of the silicone layer 14. The blocking switch 20 can be actuated directly by the user of the power tool 50, while the membrane 22 can be actuated indirectly by the switching section 26a of the rotary lever 24 when the gun handle section 28a of the rotary lever 24 is actuated, i.e. pulled in, by the user of the power tool 50. The rotary lever 24 is arranged so as to be rotatable about a pivot point 30, the pivot point 30 dividing the rotary lever 24 into a first side 26 and a second side 28. The rotary lever 24 is preferably not embodied symmetrically, and so the sides 26, 28 of the rotary lever 24 are not embodied in a manner corresponding to one another or in a similar manner. The pivot point 30 for example also need not form the centre of gravity of the rotary lever 24. The switch 10 can comprise a housing, for example.

### LIST OF REFERENCE SIGNS

10 Switch
12 Printed circuit board
14 Silicone layer
16 First microswitch or blocking microswitch
18 Second microswitch or on-off microswitch
20 Blocking switch
22 Membrane
24 Rotary lever
26 First side of the rotary lever
26a Switching section
28 Second side of the rotary lever
28a Gun handle section
30 Pivot point of the rotary lever
32 Light-emitting diodes
34 See-through regions
36 Top side of the blocking switch
38 Unblocking device
40 Spring fixing
42 Microcontroller
44 Means for deactivating the unblocked state
46 Spring
48 Switching unit
50 Power tool
52 Handle of the power tool

What is claimed is:

1. A switch for a power tool, the switch comprising:
a printed circuit board; and
a silicone layer,
the printed circuit board having a first microswitch,
the silicone layer having a blocking switch, the silicone layer being arranged on the printed circuit board such that an actuation of the blocking switch leads to an actuation of the first microswitch.

2. The switch as recited in claim 1 wherein the printed circuit board has a second microswitch, and the silicone layer has a membrane, the silicone layer being arranged on the printed circuit board such that an actuation of the membrane leads to an actuation of the second microswitch.

3. The switch as recited in claim 1 further comprising a substantially exposed second microswitch, the second microswitch being actuated by a switching section of a rotary lever.

4. The switch as recited in claim 1 wherein an actuation of the membrane or of the second microswitch is possible only if the blocking switch or the first microswitch (16) have/has been actuated beforehand.

5. The switch as recited in claim 2 wherein an actuation of the membrane or of the second microswitch is effected by an actuation of a gun handle section the gun handle section being present arranged on a second side of a rotary lever of the switch.

6. The switch as recited in claim 5 wherein the rotary lever is embodied so as to be rotatable about a pivot point, the pivot point subdividing the rotary lever into a first side and a second side, a switching section being present arranged on the first side (26) of the pivot point, the switching section being configured to actuate the membrane or the second microswitch.

7. The switch as recited in claim 1 wherein an actuation of the blocking switch or of the first microswitch leads to unblocking of the power tool, such that the power tool can be switched on.

8. The switch as recited in claim 1 wherein an unblocked state of the power tool is activated by an actuation of the blocking switch or of the first microswitch.

9. The switch as recited in claim 8 wherein the unblocked state of the power tool is deactivated after a predefined time period has elapsed.

10. The switch as recited in claim 1 wherein the printed circuit board includes light-emitting diodes, and the silicone layer has at least one see-through region (34) embodied in a manner corresponding thereto, such that light emission by the light-emitting diodes is recognizable by a user of the power tool.

11. The switch as recited in claim 10 wherein the at least one see-through region is arranged on a top side of the blocking switch.

12. The switch as recited in claim 1 further comprising an unblocking device, the unblocking device having to be actuated in addition to the blocking switch or the first microswitch in order to activate an unblocked state of the power tool.

13. The switch as recited in claim 1 further comprising a deactivator enabling an unblocked state of the power tool to be deactivated.

14. A method for switching on a power tool, the power tool having the switch (as recited in claim 1, the method comprising:
actuating the blocking switch to actuate the first microswitch.

15. The method as recited in claim 14 wherein the printed circuit board has a second microswitch, and the silicone layer has a membrane, the silicone layer being arranged on the printed circuit board such that an actuation of the membrane leads to an actuation of the second microswitch, an actuation of the membrane being possible only if the blocking switch or first microswitch has been actuated beforehand.

16. The method as recited in claim 14 wherein the printed circuit board has a substantially exposed second microswitch, the second microswitch being actuated by a switching section of a rotary lever, an actuation of the second microswitch being possible only if the blocking switch or the first microswitch has been actuated beforehand.
